(19) United States
(12) Patent Application Publication
(10) Pub. No.: US 2019/0385592 A1
(43) Pub. Date: Dec. 19, 2019

(54) SPEECH RECOGNITION DEVICE AND SPEECH RECOGNITION METHOD

(71) Applicant: LG ELECTRONICS INC., Seoul (KR)

(72) Inventors: Wonho SHIN, Seoul (KR); Jichan MAENG, Seoul (KR)

(73) Assignee: LG ELECTRONICS INC., Seoul (KR)

(21) Appl. No.: 16/552,735

(22) Filed: Aug. 27, 2019

(30) Foreign Application Priority Data
Aug. 12, 2019 (KR) 10-2019-0098461

(51) Int. Cl. G10L 15/06; G10L 15/32; G10L 15/16

(52) U.S. Cl. CPC G10L 15/063; G10L 15/16; G10L 15/32

(57) ABSTRACT

A speech recognition method includes learning a first learning model to obtain first speech data corresponding to first training data, learning a second learning model to obtain a first speech recognition result corresponding to second training data, and controlling to change a parameter of the first learning model based on an error of the obtained first speech recognition result. The second training data may be first speech data.

### CROSS-REFERENCE TO RELATED APPLICATIONS

Pursuant to 35 U.S.C. § 119(a), this application claims the benefit of earlier filing date and right of priority to Korean Patent Application No. 10-2019-0098461, filed on Aug. 12, 2019, the contents of which are hereby incorporated by reference herein in its entirety.

### BACKGROUND

The present disclosure herein relates to a speech recognition device and a speech recognition method.

Recently, technology for recognizing voice has been explodingly developed by combining artificial intelligence, IoT, robots, and autonomous vehicles.

Since the utterance of the speaker must be correctly recognized so that subsequent operations can be performed without malfunction in speech recognition, in relation to in speech recognition, it is very important to increase the recognition rate of speech recognition. However, in the conventional speech recognition device, the recognition rate of the speech recognition is not high yet, there may be situations in which the error of the speech recognition causes the robot to give an incorrect answer to the utterance of a speaker and a guide message is sent to inform the speaker that the utterance of the speaker is not understood.

### SUMMARY

The embodiment aims to solve the above and other problems.

Another object of the embodiment is to provide a speech that can increase the recognition rate of speech recognition or improve the recognition performance based on artificial intelligence.

In one embodiment, a speech recognition method includes: learning a first learning model to obtain first speech data corresponding to first training data; learning a second learning model to obtain a first speech recognition result corresponding to second training data; and controlling to change a parameter of the first learning model based on an error of the obtained first speech recognition result.

In another embodiment, a speech recognition device includes: a memory configured to store a first learning model and a second learning model; and a processor. The processor learns the first learning model to obtain first speech data corresponding to first training data, learns the second learning model to obtain a first speech recognition result corresponding to second training data, and controls to change a parameter of the first learning model based on an error of the obtained first speech recognition result.

The additional scope of applicability of the embodiment will become apparent from the following detailed description. However, since various changes and modifications within the spirit and scope of the embodiment may be understood by those skilled in the art, it should be understood that the specific embodiments, such as the detailed description and the preferred embodiments, are given as examples only.

### BRIEF DESCRIPTION OF THE DRAWINGS

FIG. 1 illustrates an AI device 100 according to an embodiment of the present invention.

FIG. 2 illustrates an AI server 200 according to an embodiment of the present invention.

FIG. 3 illustrates an AI system 1 according to an embodiment of the present invention.

FIG. 4 is a block diagram illustrating a speech recognition device according to an embodiment of the present invention.

FIG. 5 is a flowchart illustrating a method of operating a speech recognition device according to an embodiment of the present invention.

FIG. 6 is a flowchart illustrating a method of improving speech recognition performance using reinforcement learning.

FIG. 7 is an exemplary view illustrating a method of operating a speech recognition device according to an embodiment of the present invention.

### DETAILED DESCRIPTION OF THE EMBODIMENTS

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

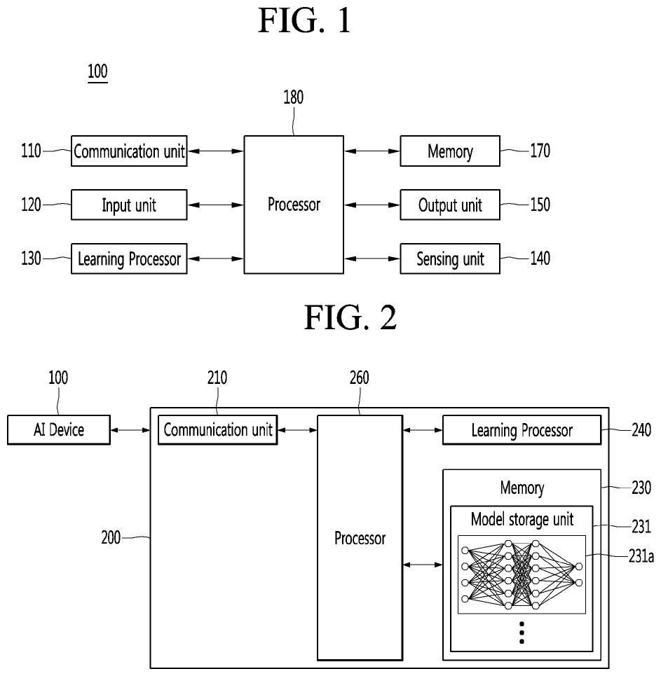

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™ RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

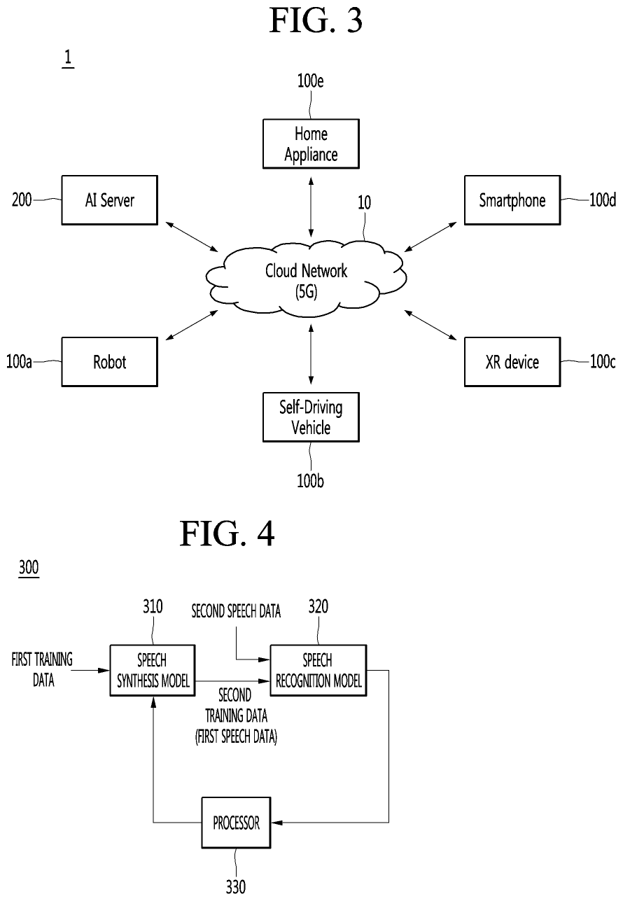

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

FIG. 4 is a block diagram illustrating a speech recognition device according to an embodiment of the present invention.

Referring to FIG. 4, the speech recognition device 300 according to an embodiment of the present invention may include a speech synthesis model 310, a speech recognition model 320, and a processor 330. The speech synthesis model 310 and the speech recognition model 320 may be included in the memory 170 shown in FIG. 1. The processor 330 may be the processor 180 shown in FIG. 1. The speech synthesis model 310 may be referred to as a first learning model, and the speech recognition model 320 may be referred to as a second learning model. The speech synthesis model 310 may be generated based on text-to-speech (TTS). The speech recognition model 320 may be generated based on speech-to-text (STT).

The processor 330 may control the speech synthesis model 310 or the speech recognition model 320. That is, the processor 330 may operate the speech synthesis model 310 or the speech recognition model 320 for learning. For example, the processor 330 may operate the speech synthesis model 310 or the speech recognition model 320 when receiving input data. For example, the processor 330 may operate the speech synthesis model 310 or the speech recognition model 320 when the speech recognition device 300 operates.

The speech synthesis model 310 may learn first training data to obtain first speech data corresponding to the first training data.

The first training data can be, for example, text data based on text. The first training data may include, for example, text data and speech data corresponding to the text data in pairs. Accordingly, the speech synthesis model 310 may learn text data of the first training data and output the first speech data. The speech synthesis model 310 may learn speech data of the first training data and output the first speech data. The speech synthesis model 310 may learn text data of the first training data and speech data corresponding thereto together to output the first speech data. The speech data of the second training data may be a speech spectrum converted from text data.

The first training data may be collected in advance, but not limited thereto. For example, the first training data may be a word included in the electronic dictionary. For example, the first training data may be a local dialect obtained by field visits to each province.

Accordingly, the speech synthesis model 310 may learn text data of the first training data and output speech data (first speech data) based on speech corresponding to the text.

The first speech data is provided to the speech recognition model 320 to be used for learning speech recognition. That is, the first speech data may be used as training data for learning the speech recognition model 320.

According to an embodiment of the present invention, by obtaining the training data for speech recognition using the speech synthesis model 310, there is no need to collect training data for speech recognition, which facilitates the learning of speech recognition.

The speech recognition model 320 may acquire first speech recognition results corresponding to the first speech data by learning the first speech data. The speech recognition model 320 may learn speech recognition based on the first speech data. The first speech data may be data obtained from the speech synthesis model 310. The first speech recognition result may be text data. The speech recognition model 320 may learn so that the text of the text data corresponds exactly to the speech of the first speech data.

According to the present invention, the controller 330 may control to change the parameter of the speech synthesis model 310 based on the first speech recognition result obtained from the speech recognition model 320.

In order to change the parameters of the speech synthesis model 310, a target to which the first speech recognition result can be compared, that is, a second speech recognition result, should be obtained.

For this, the speech synthesis model 310 may learn the second speech data to obtain a second speech recognition result corresponding to the second speech data. The second speech data may be data based on actual speech. For example, the second speech data may be data generated based on the actual speech of ‘eat’.

In addition, the first training data, the first speech data and the second speech data may be data based on the same text.

For example, the first speech data and the second speech data may be data based on text ‘eat’. That is, the speech synthesis model 310 may acquire first speech data corresponding to the first training data by learning the first speech data of ‘eat’. The speech recognition model 320 may acquire the first speech recognition result corresponding to the first speech data by learning the first speech data of ‘eat’. In addition, the speech recognition model 320 may acquire second speech recognition results corresponding to the second speech data by learning the second speech data generated based on the actual speech of ‘eat’. For convenience, the word ‘eat’ is used as an example, but is not limited thereto, and the sentence “how is the weather today” is possible. In addition, short or long texts are possible.

The processor 330 may obtain an error value between the first speech recognition result and the second speech recognition result by comparing the second speech recognition result with the first speech recognition result. Here, since the second speech recognition result is obtained by learning second speech data based on the actual speech, the second speech recognition result may be determined as a right answer.

Thus, the processor 330 may obtain the error value according to how accurate the first speech recognition result is as compared to the second speech recognition result. For example, when the second speech recognition result is obtained with the text data of ‘eat’ and the first speech recognition result is obtained with the text data of ‘eaaaaat’, the processor 330 may determine that a difference (or an error) occurs between the first speech recognition result and the second speech recognition result, and obtain an error value according to the difference. The error value may be a value corresponding to the difference between the first speech recognition result and the second speech recognition, but is not limited thereto. For example, if the first speech recognition result and the second speech recognition result are text based, a numerical value or vector value indicating a difference between the text of the first speech recognition result and the text of the second speech recognition result may be set, and therefore, a numerical value or a vector value corresponding to the difference can be obtained as an error value.

The processor 330 may control to change a parameter of the speech synthesis model 310 based on an error value between the first speech recognition result and the second speech recognition result. The parameter of the speech synthesis model 310 is a control parameter that can change the output value of the speech synthesis model 310, that is, the first speech data, and for example, may include one or more of accent, intonation, level of voice, intensity, or length.

If the parameters of the speech synthesis model 310 are changed, the speech synthesis model 310 may acquire first speech data corresponding to the first training data by learning the first training data based on the changed parameter. At this time, the first speech data may be changed by the changed parameter.

The speech recognition model 320 may acquire first speech recognition results corresponding to the first speech data by learning the changed first speech data. At this time, since the first speech recognition result is also obtained by learning the changed first speech data, it may be different from the previous first speech recognition result.

The processor 330 may obtain the error value by comparing the changed first speech recognition result with the second speech recognition result, and change a parameter of the speech synthesis model 310 according to the error value. By repeatedly changing the parameters of the speech synthesis model 310, the error value between the first speech recognition result and the second speech recognition result obtained in the speech recognition model 320 may be minimized, or the first speech recognition result may be the same as the second speech recognition result. The present invention can be performed by reinforcement learning to minimize the error value through such iterative learning.

According to an embodiment of the present invention, by performing reinforcement learning to reduce the error of the speech recognition result obtained in the speech synthesis model 310, the performance of speech recognition can be improved.

Given an environment where an agent can determine what to do every moment, reinforcement learning is a theory that is capable of finding the best way through experience without data.

Reinforcement learning may be performed by a Markov Decision Process (MDP). When the Markov Decision Process (MDP) is briefly described, firstly, an environment is given that contains the information the agent needs to do the following actions. Second, define how the agent behaves in that environment. Third, define a score for what the agent does well and a penalty for what the agent doesn't do well. Fourth, this will be repeated until the future reward reaches its peak, leading to the optimal action policy.

This MDP may be applied to the speech recognition device 300 according to an embodiment of the present invention.

Specifically, first, an environment where the speech recognition device 300 is provided with an output or pattern of output values such as speech recognition results in the speech recognition model 320 in order to update the parameters of the speech synthesis model 310 is given. Secondly, define the speech recognition device 300 to behave such that the output follows the baseline to achieve the goal. Third, as the speech recognition device 300 follows the baseline, rewards are given. Fourth, the processor 330 of the speech recognition device 300 repeats the learning until the total sum of the rewards becomes maximum to derive an optimal control function.

In this case, the speech recognition device 300 may update the parameters of the speech synthesis model 310 based on the output value, that is, the speech recognition result.

The speech recognition model 320 and speech synthesis model 310 may be learned based on supervised learning.

Supervised learning is a type of artificial neural network and is a method of machine learning to infer a function from training data. Among the inferred functions, the continuous value output can be called regression, and the prediction and output of the class of the input vector can be called classification.

In supervised learning, an artificial neural network is learned with a given label of training data. The label may mean a correct answer (or result value) that the artificial neural network should infer when training data is inputted to the artificial neural network.

In this specification, when training data is inputted, the correct answer (or result) that the artificial neural network should infer is called label or labeling data. Also, in this specification, labeling training data for learning artificial neural networks is called labeling the labeling data to the training data. In this case, the training data and a label corresponding to the training data constitute one training set, and may be input to the artificial neural network in the form of a training set.

Meanwhile, training data represents a plurality of features, and labeling the training data may mean that the feature represented by the training data is labeled. In this case, the training data may represent the feature of the input object in a vector form.

In supervised learning, using the training data and the labeling data, it is possible to infer a function for the association between the training data and the labeling data. The parameter of the artificial neural network may be determined (optimized) by evaluating the function inferred in such a way.

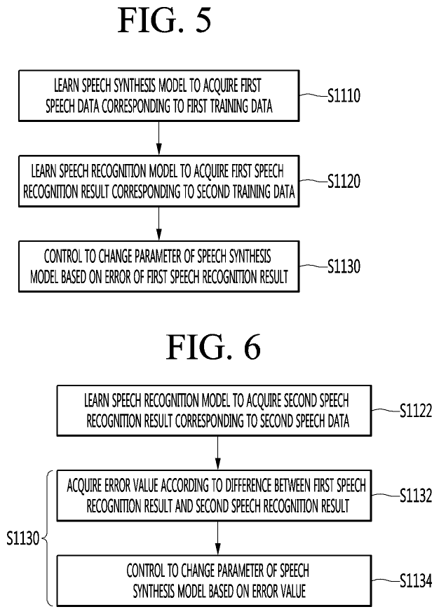

FIG. 5 is a flowchart illustrating a method of operating a speech recognition device according to an embodiment of the present invention.

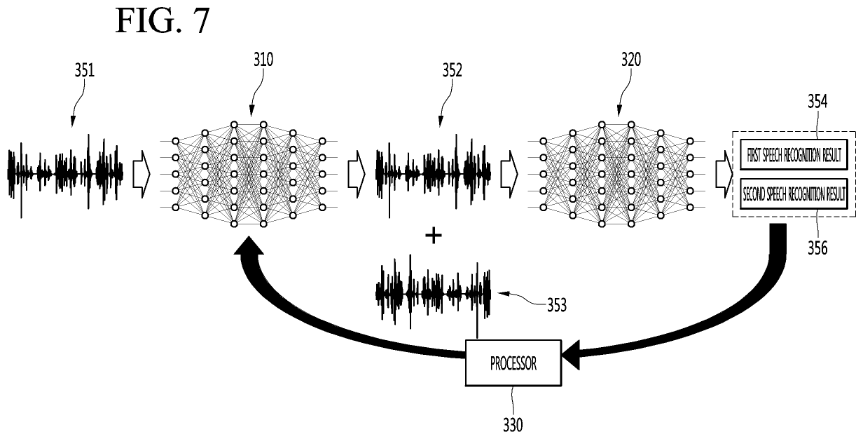

Referring to FIGS. 5 and 7, the speech recognition device 300 may learn the speech synthesis model 310 to obtain first speech data 352 corresponding to the first training data 351 (S1110).

The processor 330 may operate the speech synthesis model 310 to obtain the first speech data 352, and provide the first training data 351 to the speech synthesis model 310. The speech synthesis model 310 may acquire the first speech data 352 corresponding to the first training data 351 by learning the first training data 351. The first training data 351 may include text data, speech data and/or paired text data, and speech data corresponding thereto.

The speech recognition device 300 may learn the speech recognition model 320 to obtain a first speech recognition result 354 corresponding to the second training data (S1120).

The second training data may be first speech data 352 obtained from the speech synthesis model 310. In other words, the first speech data 352 obtained from the speech synthesis model 310 may be used for learning the speech recognition model 320.

The processor 330 may operate the speech recognition model 320 to obtain a first speech recognition result 354 and provide the second training data (first speech data 352) to the speech recognition model 320. The speech recognition model 320 may learn the first speech data 352 to obtain the first speech recognition result 354 corresponding to the first speech data 352.

According to an embodiment of the present invention, before learning the speech recognition model 320, by learning the speech synthesis model 310 to obtain first speech data 352 used as an input of the speech recognition model 320, since there is no need to hire hundreds of voice actors to collect the first speech data 352 and the time taken to generate the first speech data 352 through the hired voice actor is omitted, the learning of the speech recognition may be performed more easily.

Meanwhile, the processor 330 may control to change a parameter of the speech synthesis model 310 based on an error due to the first speech recognition result 354 obtained from the speech recognition model 320 (S1130).

In order to obtain an error value, a target that can be compared with the first speech recognition result 354 is required.

Referring to FIG. 6, the method of changing the parameters of the speech synthesis model 310 will be described in more detail. FIG. 6 is a flowchart illustrating a method of improving speech recognition performance using reinforcement learning.

Referring to FIGS. 6 and 7, the speech recognition device 300 may learn the speech recognition model 320 to obtain a second speech recognition result 356 corresponding to the second speech data 353 (S1122).

The processor 330 may operate the speech recognition model 320 to obtain a second speech recognition result 356 and provide the second speech data 353 to the speech recognition model 320. The speech recognition model 320 may learn the second speech data 353 to obtain the second speech recognition result 356 corresponding to the second speech data 353.

Here, the process of obtaining the second speech recognition result 356 may be performed simultaneously with the process of obtaining the first speech recognition result 354 or may be performed separately.

For example, in a process of obtaining the second speech recognition result 356, when the second speech recognition result 356 is obtained once by learning the second speech data 353 through the speech recognition model 320, the process of obtaining the second speech recognition result 356 may not be performed again. In this case, the obtained second speech recognition result 356 may be stored in the memory shown in FIG. 1. Then, when the first speech recognition result 354 is obtained by the speech recognition model 320, the processor 330 may load the second speech recognition result 356 stored in the memory for comparison with the first speech recognition result 354.

As another example, in a process of obtaining the second speech recognition result 356, when the recognition synthesis model acquires the first speech data 352, the processor 330 may provide the speech recognition model 320 with the first speech data 352 obtained by loading the second speech data 353 stored in the memory. Therefore, the speech recognition model 320 learns the first speech data 352 and the second speech data 353 simultaneously so that it may obtain a first speech recognition result 354 corresponding to the first speech data 352 and a second speech recognition result 356 corresponding to the second speech data 353.

The processor 330 may obtain an error value according to a difference between the first speech recognition result 354 and the second speech recognition result 356 (S1132).

The processor 330 may control to change a parameter of the speech synthesis model 310 based on the obtained error value (S1134).

Since the second speech recognition result 356 is obtained by learning the second speech data 353 generated based on the actual speech, the second speech recognition result 356 may be a baseline that is a target.

The processor 330 may change a parameter of the speech synthesis model 310 such that the second speech recognition result 356 is close to or becomes the baseline. In other words, based on reinforcement learning, the processor 330 learns the speech synthesis model 310 and the speech recognition model 320 and iteratively perform a process of changing the parameters of the speech synthesis model 310 such that the first speech recognition result 354 obtained from the speech recognition model 320 is close to or coincident with the baseline, that is, the second speech recognition result 356.

That is, when the first speech recognition result 354 obtained from the speech recognition model 320 has a first difference from the second speech recognition result 356, the processor 330 may obtain a first error value according to the difference, and change the speech synthesis model 310 to the first parameter value based on the obtained first error value. The speech recognition model 320 may learn first speech data 352 obtained from the speech synthesis model 310 based on the changed first parameter value and obtain a first speech recognition result 354 again.

When the first speech recognition result 354 has a second difference from the second speech recognition result 356, the processor 330 may obtain a second error value according to the difference, and change the speech synthesis model 310 to a second parameter value based on the obtained second error value. Here, the second difference may be smaller than the first difference.

By descent learning that repeats this process, the first speech recognition result 354 may be close to or become the second speech recognition result 356. The fact that the first speech recognition result 354 is close to or becomes the second speech recognition result 356 or the second speech recognition result 356 may mean that the first speech recognition result 354 becomes identical to a word, phrase, or sentence corresponding to the actual speech.

Thus, according to an embodiment of the invention, through reinforcement learning about errors in speech recognition results obtained in speech recognition model 320 in addition to supervised learning in the speech synthesis model 310 and the speech recognition model 320, it is possible to significantly improve the recognition rate of speech recognition, so that in various application devices including the speech recognition device 300 of the present invention, it is possible to improve product quality and customer satisfaction by preventing malfunction due to speech recognition error.

In addition, according to an embodiment of the present invention, if the domain or language of speech recognition changes to learn a whole new speech recognition, an application device including the speech recognition device 300 of the present invention secures text data related thereto in advance and performs reinforcement learning along with supervised learning using speech synthesis model 310 and speech recognition model 320, such that even if the domain or language of the speech recognition device 300 is changed, speech recognition can be easily learned accordingly.

The effects of the speech recognition device and speech recognition method according to the embodiment are described as follows.

According to at least one of the embodiment, by obtaining the training data for speech recognition using the speech synthesis model, there is no need to collect training data for speech recognition, which facilitates the learning of speech recognition.

According to at least one of the embodiment, by performing reinforcement learning to reduce the error of the speech recognition result obtained in the speech synthesis model, the recognition rate of speech recognition can be increased or the performance of speech recognition can be improved.

According to at least one of the embodiment, if the domain or language of speech recognition changes to learn a whole new speech recognition, an application device including the speech recognition device of the present invention secures text data related thereto in advance and performs reinforcement learning along with supervised learning using speech synthesis model and speech recognition model, such that even if the domain or language of the speech recognition device is changed, speech recognition can be easily learned accordingly.

The foregoing detailed description is to be regarded as illustrative and not restrictive. The scope of the embodiment should be determined by reasonable interpretation of the appended claims, and all modifications within equivalent ranges of the embodiment are included in the scope of the embodiment.

What is claimed is:

1. A speech recognition method comprising:
learning a first learning model to obtain first speech data corresponding to first training data;
learning a second learning model to obtain a first speech recognition result corresponding to second training data; and
controlling to change a parameter of the first learning model based on an error of the obtained first speech recognition result.

2. The method of claim 1, wherein the first training data comprises a pair of text data and speech data corresponding to the text data.

3. The method of claim 1, wherein the second training data is the first speech data.

4. The method of claim 1, wherein the learning of the second learning model comprises learning the second learning model to obtain a second speech recognition result corresponding to second speech data,
wherein the controlling to change the parameter of the first learning model comprises:
obtaining an error value corresponding to a difference between the obtained first speech recognition result and the second speech recognition result; and
controlling to change a parameter of the first learning model based on the obtained error value.

5. The method of claim 4, wherein the second speech data is data based on an actual speech.

6. The method of claim 4, wherein the first training data, the first speech data, and the second speech data are data based on the same text.

7. The method of claim 4, wherein the first speech recognition result and the second speech recognition result are text data.

8. The method of claim 1, further comprising learning at least one of the first learning model or the second learning model using supervised learning.

9. The method of claim 1, wherein the controlling to change the parameter of the first learning model comprises controlling to change a parameter of the first learning model using reinforcement learning.

10. A speech recognition device comprising:
a memory configured to store a first learning model and a second learning model; and
a processor,
wherein the processor
learns the first learning model to obtain first speech data corresponding to first training data,
learns the second learning model to obtain a first speech recognition result corresponding to second training data, and
controls to change a parameter of the first learning model based on an error of the obtained first speech recognition result.

11. The speech recognition device of claim 10, wherein the first training data comprises a pair of text data and speech data corresponding to the text data.

12. The speech recognition device of claim 10, wherein the second training data is the first speech data.

13. The speech recognition device of claim 10, wherein the processor
learns the second learning model to obtain a second speech recognition result corresponding to second speech data,
obtains an error value corresponding to a difference between the obtained first speech recognition result and the second speech recognition result, and
controls to change a parameter of the first learning model based on the obtained error value.

14. The speech recognition device of claim 13, wherein the second speech data is data based on an actual speech.

15. The speech recognition device of claim 13, wherein the first training data, the first speech data, and the second speech data are data based on the same text.

16. The speech recognition device of claim 13, wherein the first speech recognition result and the second speech recognition result are text data.

17. The speech recognition device of claim 10, wherein the processor learns at least one of the first learning model or the second learning model using supervised learning.

18. The speech recognition device of claim 10, wherein the processor changes a parameter of the first learning model using reinforcement learning.
